(19) United States
(12) Patent Application Publication
(10) Pub. No.: US 2009/0259503 A1
(43) Pub. Date: Oct. 15, 2009

(54) SYSTEM AND TOOL FOR BUSINESS DRIVEN LEARNING SOLUTION

(75) Inventors: W. Mark Allen, Millburn, NJ (US); Michael T. Deimling, Chicago, IL (US); Nicole Ann McCabe, Chicago, IL (US); Steven H. Egert, Montgomery, IL (US); Brian P. Fox, Christiana, PA (US); Deanne M. George, Freeburg, IL (US)

Correspondence Address: ACCENTURE CHICAGO 28164;BRINKS HOFER GILSON & LIONE, P O BOX 10395, CHICAGO, IL, 60610, US

(73) Assignee: ACCENTURE GLOBAL SERVICES GMBH, Schaffhausen (CH)

(21) Appl. No.: 12/180,299

(22) Filed: Jul. 25, 2008

Related U.S. Application Data
(60) Provisional application No. 61/123,873, filed on Apr. 10, 2008.

(51) Int. Cl. G06F 17/00

(52) U.S. Cl. 705/7

(57) ABSTRACT

A system, method and tool are described for providing a business-driven learning solution. A learning plan is created where the learning plan is implemented in a course for a determined time period. The learning plan is displayed to a plurality of users. The learning plan is approved by the plurality of users. Thereafter, the learning plan is updated during the determined time period in accordance with changes to budget, prioritization and training needs. The updated learning plan is displayed to the plurality of users.

### CROSS-REFERENCE TO RELATED APPLICATION

This application claims the benefit of U.S. Provisional Patent Application Ser. No. 61/123,873, filed Apr. 10, 2008, which is incorporated by reference in its entirety herein.

### TECHNICAL FIELD

Generally a platform is disclosed for learning solutions and related methods for managing the learning and training of an organization.

### BACKGROUND

Employee training and education may be used to help the success of an organization. Such training and education may help employees remain knowledgeable and current in areas of expertise of the organization. A difficulty faced is that many different individuals over various organizations, or various offices within an organization, perform different functions and therefore may require different types of training.

### BRIEF SUMMARY

A system/tool/service for a business driven learning solution includes a single, web-accessible workspace to build periodic learning plans and manage them throughout a determined time period. An environment offers a streamlined way to capture client plans, manage them as business needs evolve and provide a single view of data for financials and volume planning.

Other systems, methods, tools, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

FIG. 1 is a block diagram of an environment of the system/tool/service.

FIG. 2 is a block diagram of another implementation of an annual learning plan (ALP) integration approach.

FIG. 3A-E is a flowchart of a business interlock (BI) demand planning process of the system/tool/service.

FIG. 4 is a screenshot of a welcome page for the BI tool of the BI platform.

FIG. 5 is a screenshot of a demand item list for the BI tool of the BI platform.

FIG. 6 is a screenshot of a demand item form for the BI tool of the BI platform.

FIG. 7 is a further screenshot of the demand item form of FIG. 6 for the BI tool of the BI platform.

FIG. 8 is a further screenshot of the demand item form of FIGS. 6 and 7 for the BI tool of the BI platform.

FIG. 9 is a screenshot of a user management form for administration according to a BI tool of the BI platform.

FIG. 10 is a screenshot of a list management form for administration according to a BI tool of the BI platform.

FIG. 11 is a screenshot of a product type management form for administration according to a BI tool of the BI platform.

FIG. 12 is a screenshot of an instructor type management form for administration according to a BI tool of the BI platform.

FIG. 13 is a block diagram of an exemplary general computer system that may be used with to implement the identification system.

### DETAILED DESCRIPTION

A system, tool and/or service may be used to enter, maintain and/or control an output of data/information to provide a single, comprehensive resource for work requests fed into content and development centers. The system/tool/service/service may also provide financial insight and flexibility of reporting. For example, the system/tool/service/service may be used to implement learning plans for organizations. The learning plans may include processes/services that are part of an overall scope of a business plan, such as Business Interlock (BI) manufactured by Accenture, for example one described in commonly assigned U.S. Patent Application Publication No. 2004/0002888, which is incorporated by reference herein. The system/tool/service/service may enable organizations to capture, track, and report on the learning plans. The system/tool/service/service may include detailed information about anticipated curriculum needs with an eye toward future integration with other systems and/or tools, such as Sync, Scheduling, and PM Suite.

The system/tool/service/service may provide BI teams with a single, web-accessible workspace to build annual learning plans and manage them throughout a determined time period, such as a year. An environment of the system/tool/service offers a streamlined way to capture client plans, manage them as business needs evolve and provide a single view of data for financials and volume planning. The system/tool/service may enable efficiency during the planning process by providing the single, global tool. A flexible, user-friendly platform allows multiple users to access and use the environment at one time. The solution is flexible for future expansion and integration with related demand management platforms. The tool may provide client and BPO leadership with reporting capability that are consistent across multiple users, and control how and when reports are run, such as on regular and/or ad hoc basis. The tool may allow for new resources to be joined ease of learning, administration and use of forms, such as spreadsheets. Changes may be tracked, such as against an original plan. Custom tools may be accessible by more than one user at a time. Versions of the tool may be controlled and reporting from learning plans kept consistent across engagements.

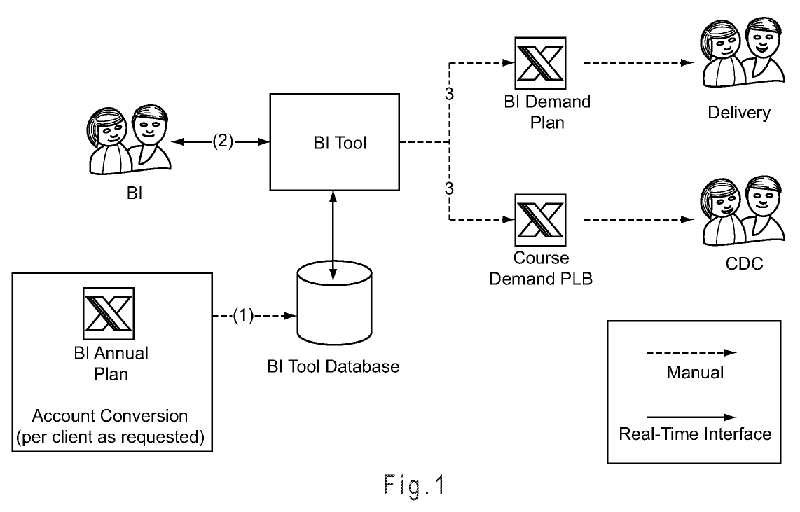

FIG. 1 is a block diagram of an environment of the system/tool/service. For the sake of explanation, the system/tool/service is described in terms of being used for inputting a tracking instructor lead training/virtual instructor lead training (ILT/vILT) and course development demand. The system/tool/service may be used for other implementations as well. The system/tool/service may be customized and used for each account to facilitate data entry, tracking, and reporting. Data from the system/tool/service may be output to users, such as in MICROSOFT WORD, or another format, such as an EXCEL format. The system/tool/service may allow multiple users over disparate systems to access to data stored on remote file servers and available outside the intranet domain. Users may concurrently update constraints at any given time. Data integrity may be maintained such that spreadsheets may be validated, management functions may be changed, etc. to help prevent possible data corruption issues that may be difficult to spot and correct. Data may be automatically exported, such as from a WORD tool, or other tool such as an EXCEL tool. The data may be reformatted and repackaged before being provided to downstream teams (i.e. delivery and content development center (CDC)). As such, the system/tool/service may provide a robust Internet or other network-enabled application that allows demand data entry, validation, and reporting capabilities. The system/tool/service may help streamline and consolidate the disparate processes used across client teams while still providing the ability to customize the solution to satisfy account-specific contractual obligations.

Terms used herein with regard to the system/tool/service include the following. A Business Interlock group works with the AL's clients to understand training needs and schedule a pipeline of work for the CDC and delivery organizations. A course may be a reusable training curriculum component. For CDC—a course may be a development deliverable to create the associated course and training materials, such as in the form of web based training. For delivery, individual session events may be created as offerings of a course. A session event may be an individual instance of a particular ILT/vILT course, such as one that is held at a specific location with an assigned instructor at a specified date/time. The CDC may be the organization within AL that is responsible for custom courseware creation and deployment. The group may support all of AL's standard content product offerings, including ILT, vILT, and web-based training (WBT), etc. Delivery may include the organization within AL that provides session scheduling and ILT/vILT based training delivery. Delivery scheduling includes the group with AL's delivery organization responsible primarily for scheduling ILT/vILT based training sessions.

A BI Tool of the system/tool/service includes technology solutions for a developed platform may be a standard scheduling web-application that interacts directly with the account specific learning management system (LMS) instances. The system/tool/service may include SYNC 2.0 or other progress tracking tool used by the CDC organization to assign course efforts and track related metadata. A delivery scheduling tool application refers to application components and views that include the delivery scheduling tool. Application components may be the user-interface that allows the delivery scheduling group to create optimized scheduled sessions for ILT/vILT courses loaded into the LMS. Additional use-case and administration capabilities may be included with the scheduling tool web application as directed by business requirements. An annual learning plan (ALP) may include a demand plan that breaks out required CDC and delivery deliverables by a client's fiscal quarter. Produced initially in conjunction with the client representatives, it may be updated and maintained throughout the year as revisions are identified and approved. A quarterly plan may include a quarterly breakdown of BI demand. This may be distributed to the CDC/Delivery groups quarterly to account for the latest demand updates. This may also provide an opportunity for the downstream teams to check capacity and availability to ensure the quarterly plan is achievable.

FIG. 1 identifies applications of the system/tool/service and the relationships between the applications. In FIG. 1, connections among the applications may serve as a construction blueprint to ensure consistency across systems. FIG. 1 illustrates a basic application design and related components and integrations. As part of an initial demand upload, a 1X Account transition (for each account), the current annual plan data is uploaded into the BI Tool. Maintenance of demand may occur in the BI Tool following the conversion. Conversion may be automated (if funded/arranged by the account team) or manually entered by Account personnel. BI creates/manages an account annual learning plan (ALP). The learning plan includes individual demand events for both CDC and Delivery organizations. Demand events are distributed to the downstream organizations. Demand for delivery may come in the form of annual/quarterly demand plans in a medium such as WORD and/or EXCEL. Demand for CDC may include listed PLB elements.

With regard to application components, the BI Tool system/service may include of the following basic applications and components. An ASP.NET presentation layer or other web-based presentation layer may supply the application views and operate as the interface for end-users. The application views may interact directly with the SQL Server database, or other database, via stored procedures to supply dynamic and database driven content. The SQL Server database may also contain components such as stored procedures, views, and OLAP cubes (such as if required by reporting specifications) for reporting.

With regard to external system integrations, the BI Tool may include various types of external system integrations, including initial demand conversion, delivery demand data uploads and CDC demand data uploads. The initial demand conversion may be account dependent. Some client account teams may choose to have their existing annual plan worksheets uploaded directly into the BI Tool database. Conversion effort may be considered on an account-by-account basis and funded by the account team. Delivery demand data uploads may be implemented for quarterly demand-type requests, or other inputs, such as for session change requests. CDC demand data uploads may upload data to the SYNC 2.0 platform to push the PLB data into individual event records.

The following describes the technical architecture that may be used to support the business applications. The technical architecture may include the development, execution, and operations environments. The following technologies may be included in the BI Tool system/tool/service technology platform. ASP.NET (v2.0), a MICROSOFT-based unified web development model that includes the services necessary for to build enterprise-class web applications. The BI Tool's ASP.NET components may include the both the .asp web files for the application presentation layer as well as the .DLL components that will contain application logic, error handling, and database connectivity functionality. MICROSOFT Internet information services (IIS), a web server to provide a reliable, manageable, and scalable web application infrastructure.

The IIS server in conjunction with ASP.NET and Active Directory components servers as the basic platform that may host the BI Tool and enforce application authentication and security. Information may be filtered to a user depending on an access level of the user, such as based on the users' profile and/or role. An active directory as a specific enterprise LDAP service may be used for all BI Tool authentication requirements. Advantages to using active directory include less administrative overhead to obtain system access and maintain user passwords, tighter security loopholes for users that leave the firm, and the lack of a separate account/password for each user. A visual source safe (VSS) may be used such as with the BPO source control solution. It may be used for software change management functions for the BI Tool application development including storage, retrieval, and change control of all application source files. VSS integrates seamlessly with the MICROSOFT Visual Studio IDE. A visual studio such as a MICROSOFT-based integrated development environment (IDE) that is used by developers to create and maintain ASP.NET application files. The visual studio includes capabilities to deploy local workstation versions of applications and debugging tools to assist with development and defect resolution.

The system/tool/service also utilizes a database such as SQL Server 2005, MICROSOFT's enterprise-class database software. The SQL Server database used for the BI Tool may be used as the primary application database. In addition to general data storage, SQL Server 2005 also includes the following components or add-ons that may potentially be leveraged with the system/tool/service. Stored Procedures (SP) are compiled SQL statements deployed to the SQL Server database that execute quickly for run-time invocation by the calling application. Benefits of SP use over SQL queries may include faster data execution and abstraction of data logic from application code. Data transformation services (DTS) or other tools, such as those available in MICROSOFT SQL Server that lets you extract, transform, and consolidate data from disparate sources into single or multiple destinations supported by DTS connectivity. DTS may be used to package data for external system or data integrations. SQL Server 2005 or other reporting services delivers enterprise, and web-enabled reporting functionality may be utilized so developers can create reports that draw content from a variety of data sources, publish reports in various formats, and centrally manage security and subscriptions. Reporting services works in conjunction with MS OLAP based reports to allow flexible user driven reporting. Online analytical processing (OLAP) allows multidimensional data analysis and reporting. Used in conjunction with MS Reporting Services, OLAP allows developers to create data sources that can be custom configured by end-users to shape the reporting data format to their needs. SHAREPOINT, a MICROSOFT platform for internet-based file and ticket creation and storage may be used on the BI Tool in the following capacities. With regard to project documentation storage and change control, project files may be stored and versioned in a separate project directory. This shared location may allow team members to access documentation over the Internet and to maintain version control for shared documentation. SQE defect forms and tickets may be created and distributed, such as to team members for test phase of the BI Tool development effort.

The BI Tool system/service may include a multi-tier security approach to ensure access the application and the data components may be restricted to authorized users. The following security considerations, for application security, report security and application database server accessibility, may be factored into the application and architecture design. With regard to application security, the BI Tool may be designed with the following security standards. HTTPS-based Internet Application may be implemented such that the BI Tool employs Secure Socket Layer (SSL) security employing a valid application certificate. These certificates allow the data transmission between the end user's internet browser and the application server, such as to utilize 128-bit or greater encryption. Active directory authentication may be used such that all application users are required to authenticate against a company's active directory LDAP service. This ensures that all users are valid employees or other users, and requires no manual administrative effort to restrict access to users who have left the company. Role-based security may be used with the BI Tool application to maintain a user table that restricts access only to permitted company users. The user table may also contain role-mappings that will allow the application to restrict certain privileges programmatically within the tool. A session timeout may be used with the application to have a session timeout framework that requires users re-login to the application after a specified period of time. This ensures that open application sessions cannot be used by non-authorized individuals. With regard to report security, all BI Tool OLAP reports may have a defined user group added to the OLAP cube membership log to restrict access only to authorized users. With regard to application database server accessibility, to comply with company standards, the web/application servers (internet facing) may communicate with the application database server (non-internet facing). The application database may only be accessible within the company's network.

Application performance in the BI Tool system/service may ensure positive BI productivity and the ability to meet the business case objectives. Since the BI Tool may be accessed by a wide set of globally disbursed end-users, several performance considerations are utilized early on in the project design/build phase. Application Performance Benchmarks of the BI Tool application requirements include performance targets for application views and reports. The target benchmarks should be included in the SQE testing plan to ensure the application meets the overall performance guidelines. For database tuning, the BI Tool includes a database intensive application relying on stored procedure-based queries and OLAP cube technology for application reporting. Stored procedure tuning may include a SQL Server SME code-reviewing all application stored procedures to ensure proper and efficient data queries. Where specific page views are found to exceed the prescribed performance guidelines, targeted stored procedure tuning may be employed. All database tables may be appropriately indexed. OLAP reports may be designed with performance in mind. Where possible, the system/tool/service may consider end-users needs to increase report filters and reduce report row fields. Developers may follow software coding best practices to ensure that the deployed application is as efficient as possible. In addition to SEDC's coding standards, ASP.NET guides are available that describe coding for application performance. For reduced network data transmission, the application design may be set up to minimize the data volume between the client and server as much as possible. Techniques include performing data intensive tasks server-side and only sending the dynamic data required for the presentation layer. The BI Tool may require daily batch feeds between itself and the downstream systems (SYNC and Delivery Scheduling Tool). These feeds and any batch processes may be scheduled (where possible) around the working times of the various account scheduling teams to minimize end user impact to performance intensive operations.

The BI tool may be utilized in BI's demand management process. Its design may be flexible to support multiple user role types, use cases, and account-specific configurations. The BI Tool may be used to support various use cases to meet determined business requirements, such as demand planning, reporting and administrative functions. Demand planning allows BI users to add/edit/delete demand events for delivery and CDC organizations. Demand lists allow filtering to locate a given record, and the ability to navigate to the corresponding demand form page for editing. The BI Tool may provide reporting capabilities to view aggregate demand data and forecasting. Also, administrative functions may provide for determined application users and list management. Determined application users may allows administrators to add/remove users and assign appropriate role types. A list management capability may provide account specific values for list dropdowns contained on any application form page. This may allow for consistency and uniformity across users with editing permissions and include capabilities to Add/Edit/Inactivate list items.

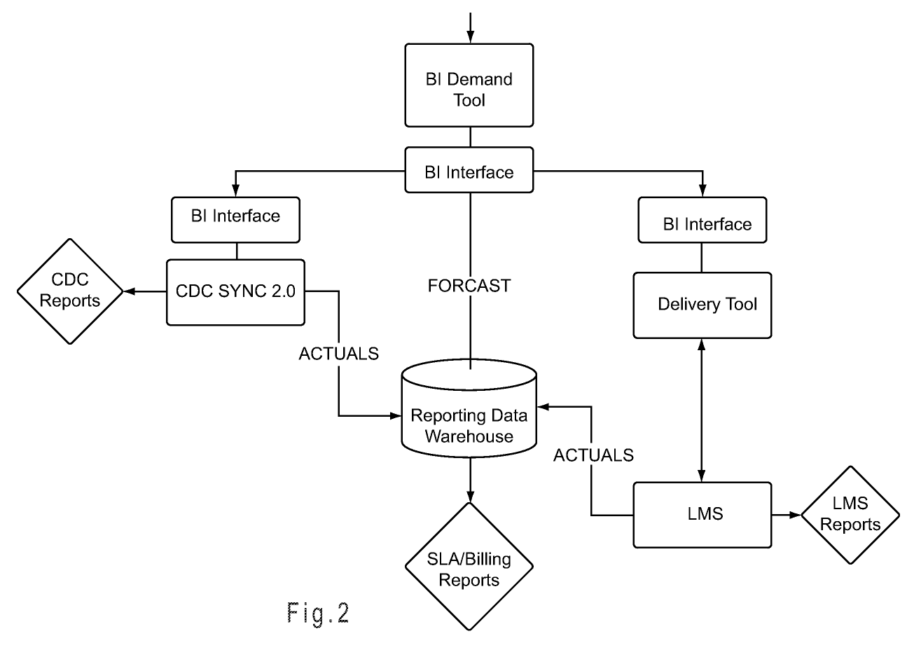

FIG. 2 is a block diagram of another implementation of the AL integration approach. The BI Tool may be one of several AL initiatives aimed at increasing standardization across accounts and providing enhanced technology support to their respective organizations. Several of the organizations may work closely together and have recurring data interfaces shared between them. The BI tool may include any integration between downstream groups. The application requirements and design may factor in the eventual integration of future enhancement. FIG. 2 shows how the BI Tool may push demand output as an input to the delivery session scheduling function and CDC's projects. As part of the BI Tool and BI Tool projects, the assigned project functional and technical architects discuss common data sets and file integration data points. Any required downstream data fields may be included for both efforts to allow future development of automated integrations.

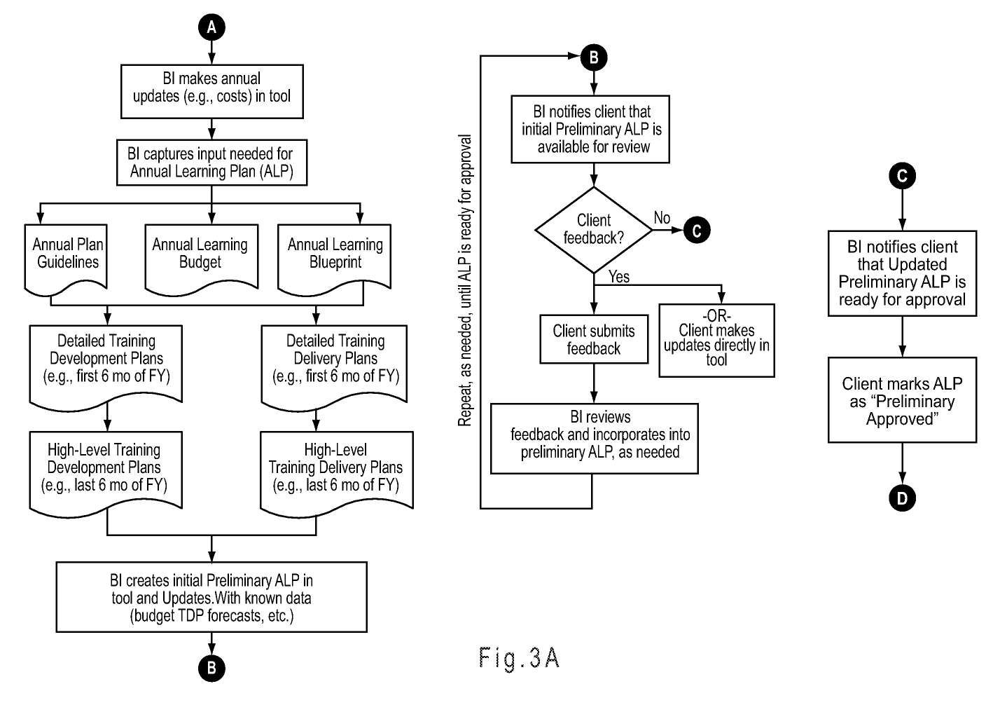

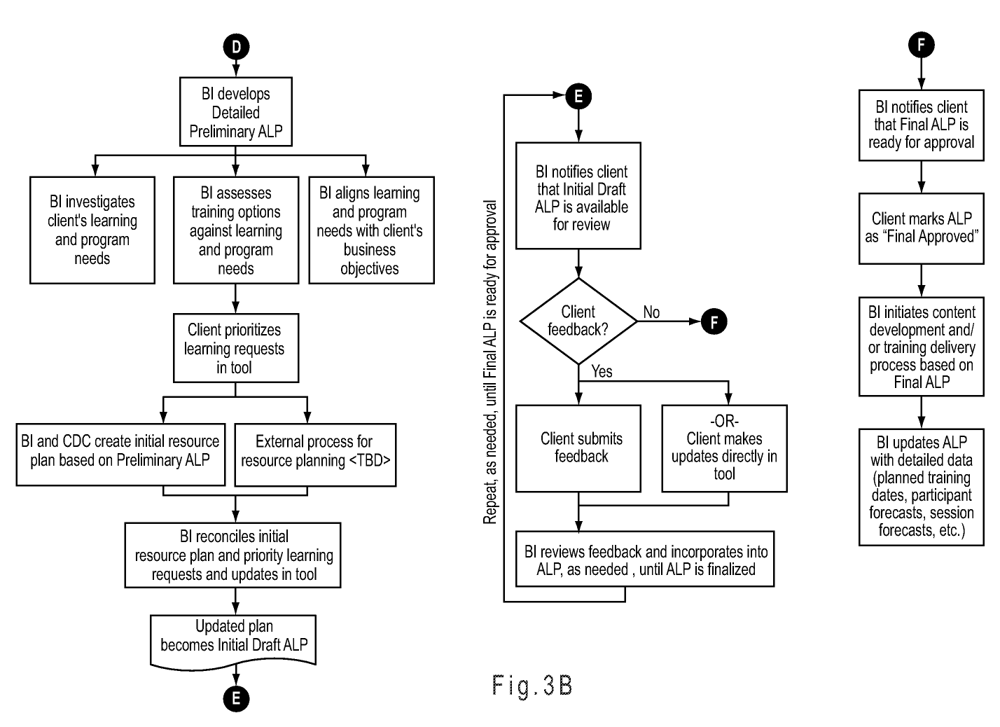

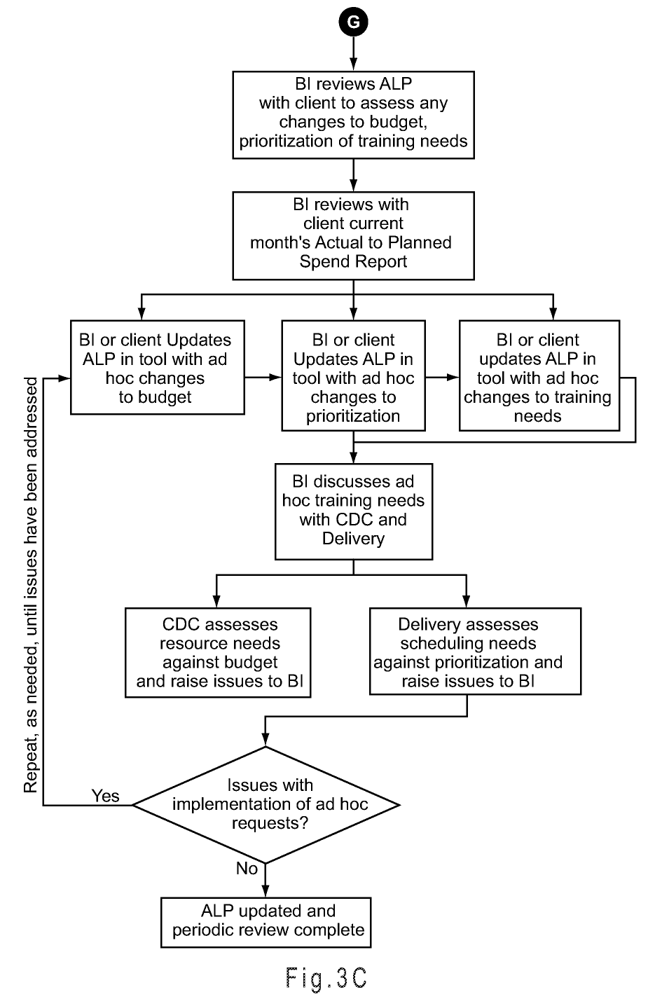

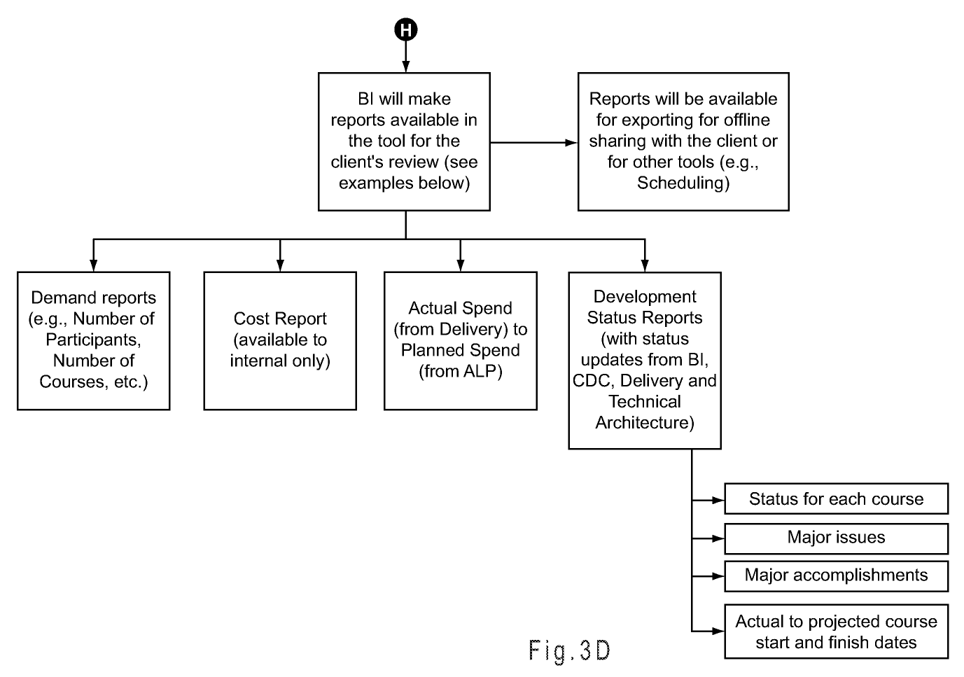

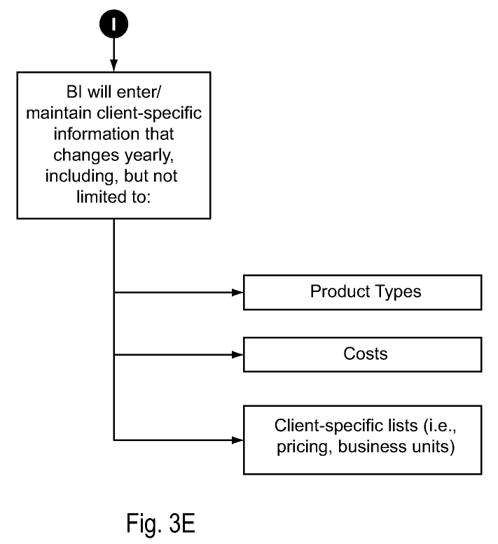

FIG. 3A-E is a flowchart of a BI demand planning process of the system/tool/service. Processes may be noted as being within or occurring outside of the BI tool, but in other implementations more or less of the processes may occur within the tool, such that all of the processes may occur within the tool. FIG. 3A illustrates a process for a preliminary annual learning plan (ALP). For the sake of description, the plan is described as being an annual plan, but other time frames may be used. FIG. 3B illustrates a process for draft and final ALP. These parts of the processes may occur about three months before the start of the timeframe, such as three months before the start of the fiscal year. FIG. 3C illustrates periodic review of ALP. The periodic review may begin the first of the fiscal year and occur regularly through the end of the year, such as quarterly, monthly, or as otherwise needed. FIG. 3D illustrates reports that may be available with the process. The illustrated reports are not exhaustive of all reports that may be available in the tool, and more or less reports may be available. The reports are listed for exemplary purposes to help depict the reporting process. FIG. 3E illustrates annual process of the tool. These processes may occur at the beginning of the fiscal year.

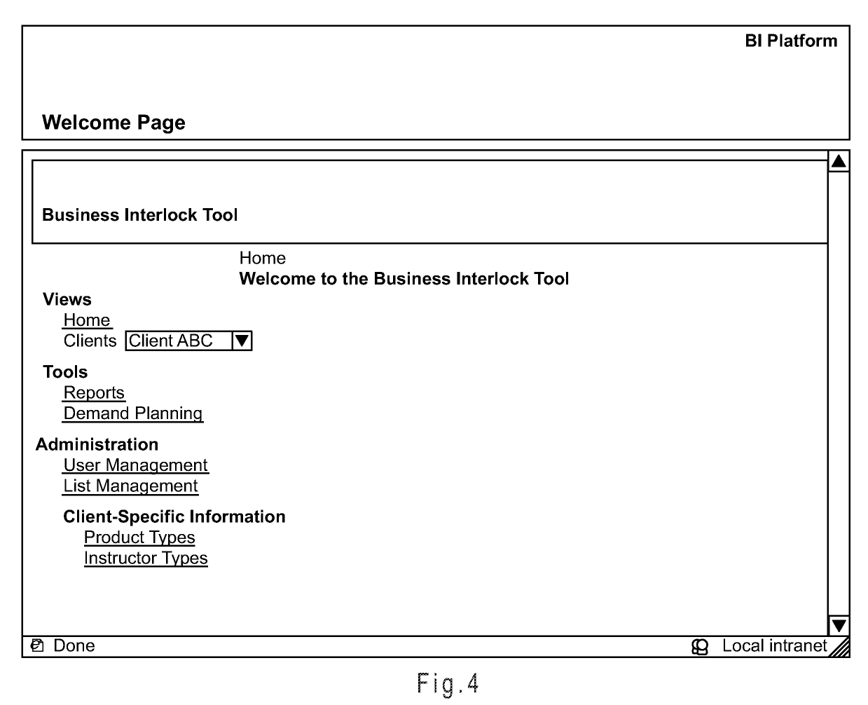

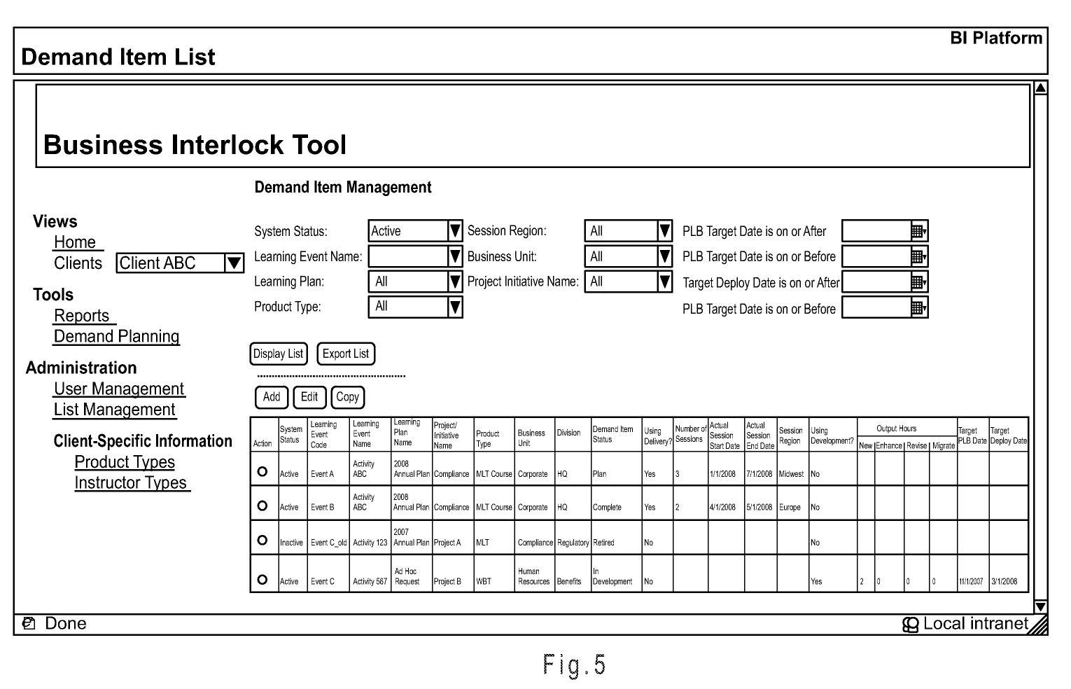

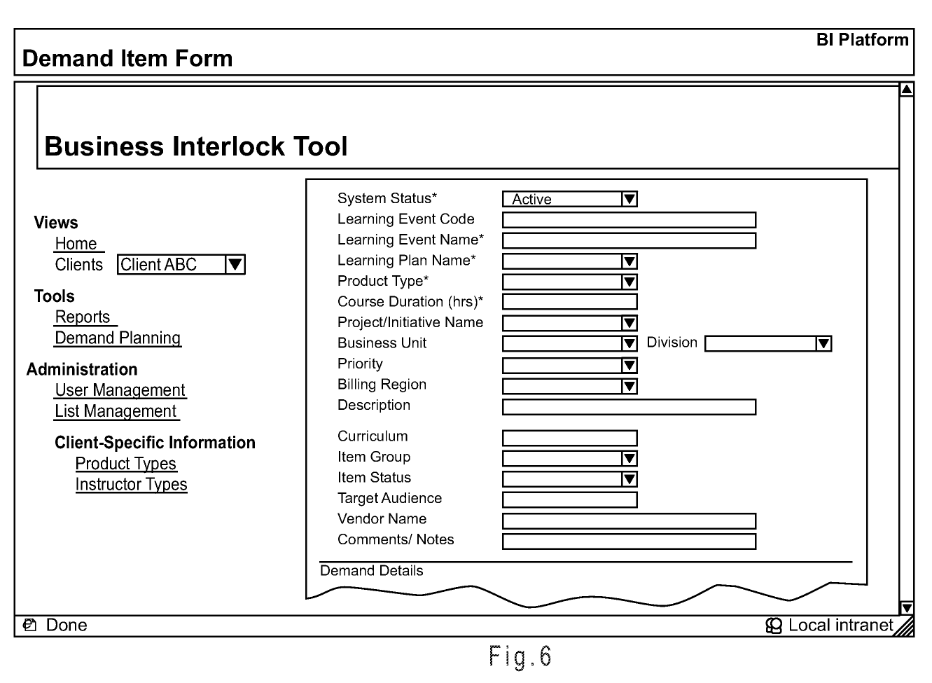

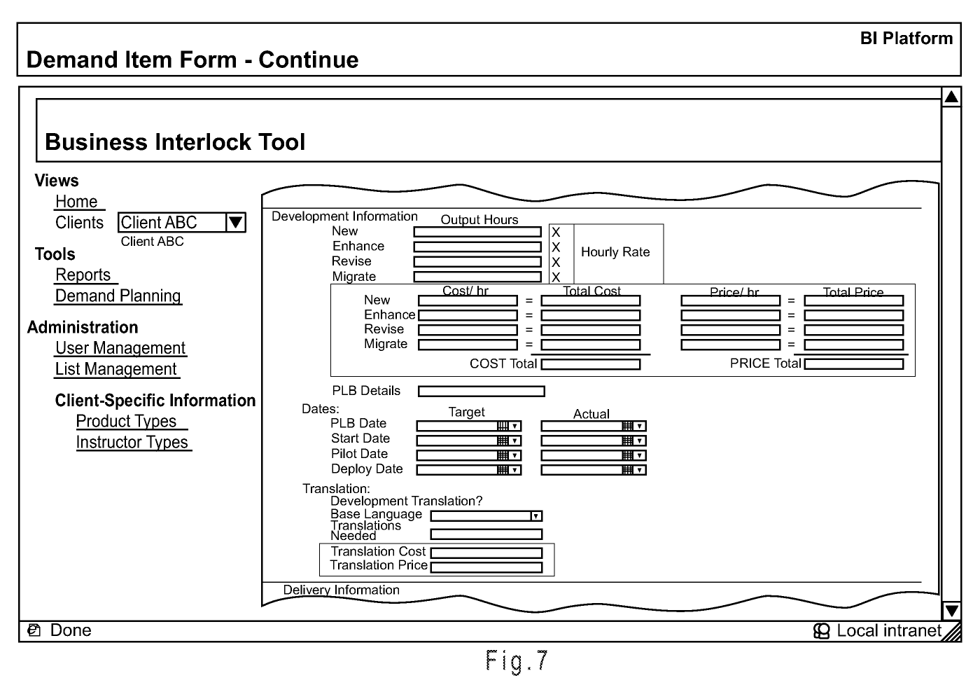

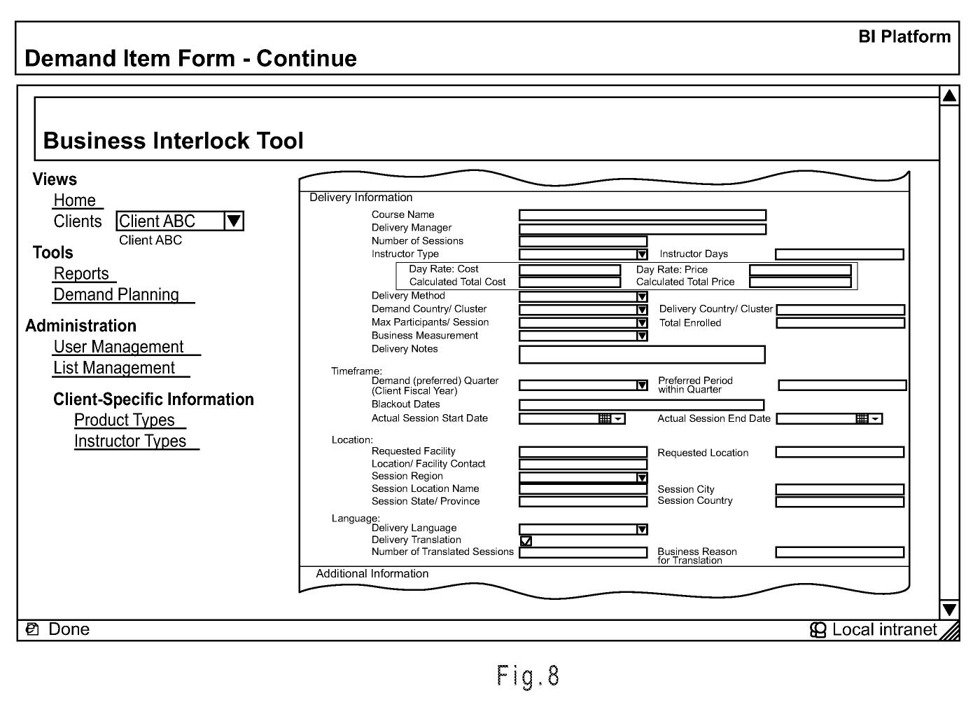

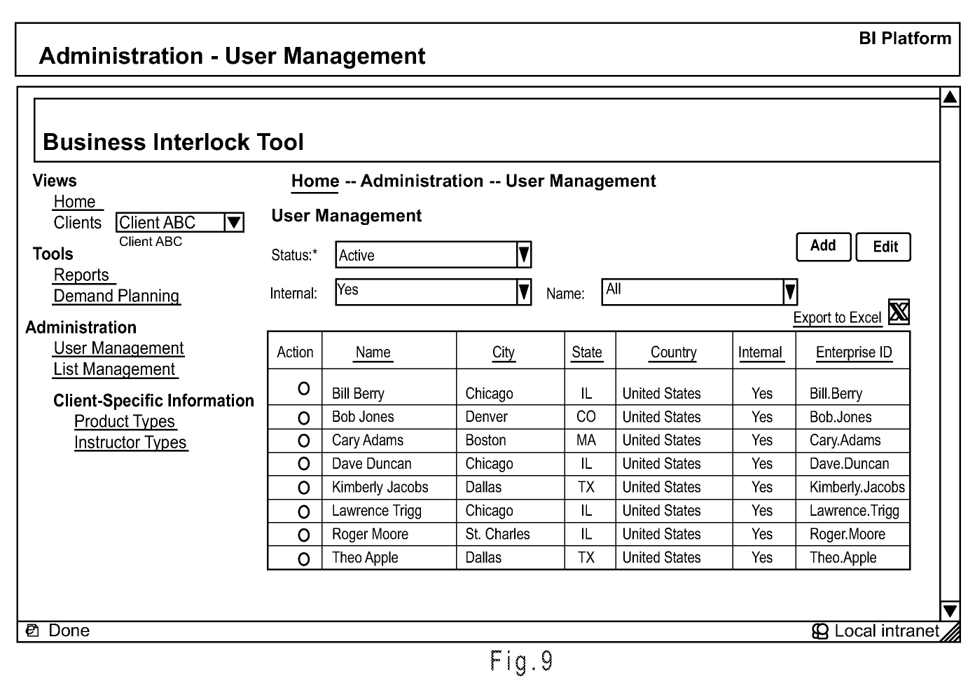

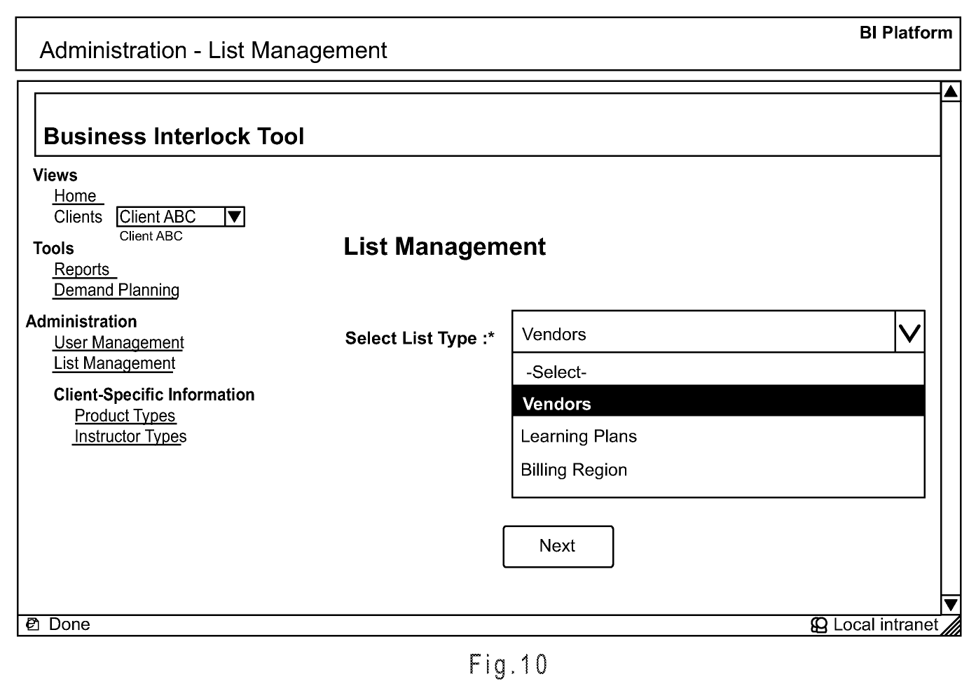

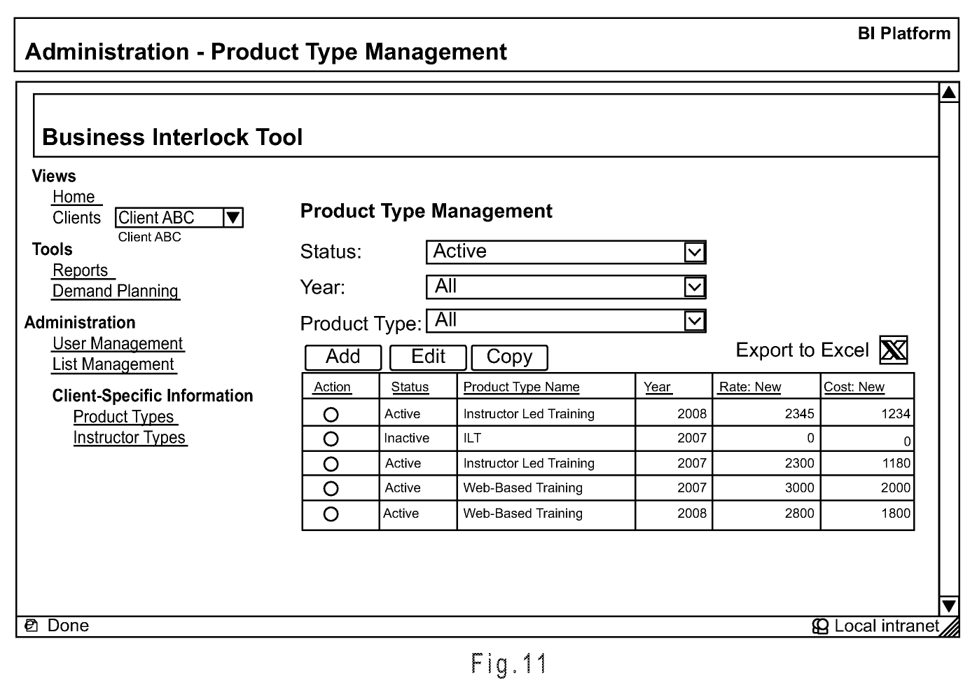

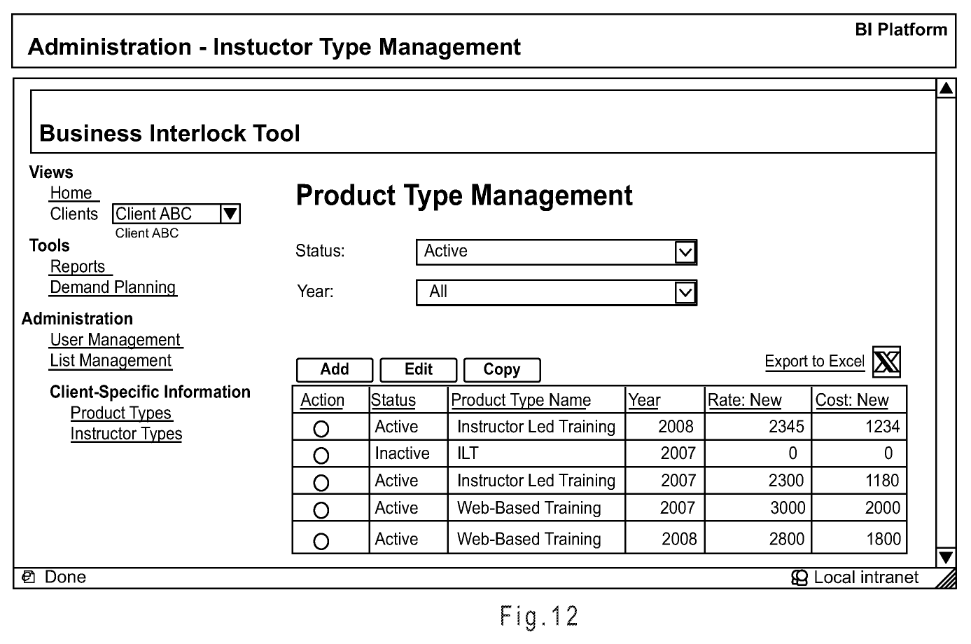

With regard to the system/tool/services described above, FIG. 4 is a screenshot of a welcome page for the BI tool of the BI platform. FIG. 5 is a screenshot of a demand item list for the BI tool of the BI platform. FIG. 6 is a screenshot of a demand item form for the BI tool of the BI platform. FIG. 7 is a further screenshot of the demand item form of FIG. 6 for the BI tool of the BI platform. FIG. 8 is a further screenshot of the demand item form of FIGS. 6 and 7 for the BI tool of the BI platform. FIG. 9 is a screenshot of a user management form for administration according to a BI tool of the BI platform. FIG. 10 is a screenshot of a list management form for administration according to a BI tool of the BI platform. FIG. 11 is a screenshot of a product type management form for administration according to a BI tool of the BI platform. FIG. 12 is a screenshot of an instructor type management form for administration according to a BI tool of the BI platform.

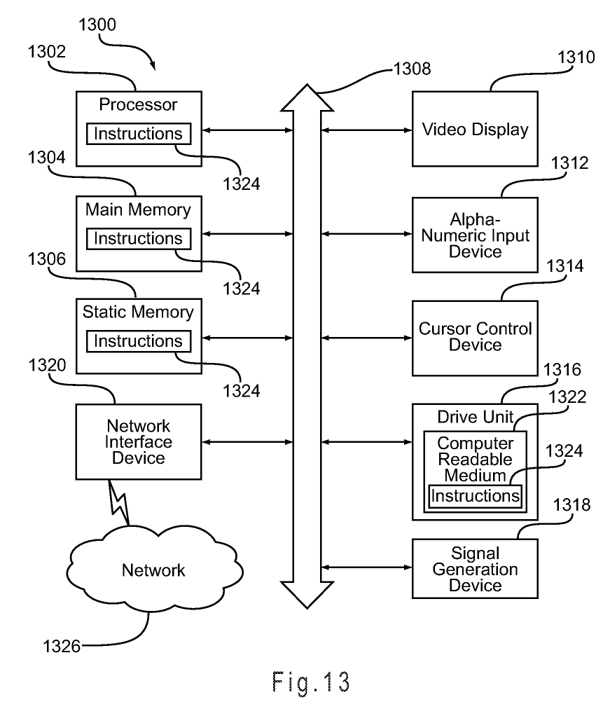

FIG. 13 is a block diagram of an exemplary general computer system 1300 that may be used with to implement the identification system. The computer system 1300 may include a set of instructions that can be executed to cause the computer system 1300 to perform any one or more of the methods or computer based functions disclosed herein. The computer system 1300 may operate as a standalone device or may be connected, e.g., using a network, to other computer systems or peripheral devices. The tool may be implemented hardware, software or firmware, or any combination thereof. Alternative software implementations may be used including, but not limited to, distributed processing or component/object distributed processing, parallel processing, or virtual machine processing may also be constructed to implement the tools described herein.

In a networked deployment, the computer system 1300 may operate in the capacity of a server or as a client user computer in a server-client user network environment, or as a peer computer system in a peer-to-peer (or distributed) network environment. The computer system 1300 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, or any other machine capable of executing a set of instructions (sequential or otherwise) that specify actions to be taken by that machine. The computer system 1300 may be implemented using electronic devices that provide voice, video or data communication. Further, while a single computer system 1300 is illustrated, the term “system” shall also be taken to include any collection of systems or sub-systems that individually or jointly execute a set, or multiple sets, of instructions to perform one or more computer functions.

The computer system 1300 may include a processor 1302, e.g., a central processing unit (CPU), a graphics processing unit (GPU), or both. Moreover, the computer system 1300 may include a main memory 1304 and a static memory 1306 that may communicate with each other via a bus 1308. The computer system 1300 may further include a video display unit 1310, such as a liquid crystal display (LCD), an organic light emitting diode (OLED), a flat panel display, a solid state display, or a cathode ray tube (CRT). Additionally, the computer system 1300 may include an input device 1312, such as a keyboard, and a cursor control device 1314, such as a mouse. The computer system 1300 may also include a disk drive unit 1316, a signal generation device 1318, such as a speaker or remote control, and a network interface device 1320.

The disk drive unit 1316 may include a computer-readable medium 1322 in which one or more sets of instructions 1324, e.g. software, may be embedded. Further, the instructions 1324 may embody one or more of the methods or logic as described herein. In a particular embodiment, the instructions 1324 may reside completely, or at least partially, within the main memory 1304, the static memory 1306, and/or within the processor 1302 during execution by the computer system 1300. The main memory 1304 and the processor 1302 also may include computer-readable media.

Dedicated hardware implementations, such as application specific integrated circuits, programmable logic arrays and other hardware devices, may be constructed to implement one or more of the tools described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit.

The present disclosure contemplates a computer-readable medium that includes instructions 1324 or receives and executes instructions 1324 responsive to a propagated signal, so that a device connected to a network 1326 may communicate voice, video or data over the network 1326. Further, the instructions 1324 may be transmitted or received over the network 1326 via the network interface device 1320. While the computer-readable medium is shown to be a single medium, the term “computer-readable medium” includes a single medium or multiple media, such as a centralized or distributed database, and/or associated caches and servers that store one or more sets of instructions. The term “computer-readable medium” also includes any medium that is capable of storing, encoding or carrying a set of instructions for execution by a processor or that cause a computer system to perform any one or more of the methods or operations disclosed herein.

The computer-readable medium may include a solid-state memory such as a memory card or other package that houses one or more non-volatile read-only memories. Further, the computer-readable medium may be a random access memory or other volatile re-writable memory. Additionally, the computer-readable medium may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A computer implemented method for providing a business driven learning solution, comprising:
creating a learning plan where the learning plan is implemented in a course for a determined time period;
displaying the learning plan to a plurality of users;
approving the learning plan by the plurality of users;
updating the learning plan during the determined time period in accordance with changes to budget, prioritization and training needs; and
displaying the updated learning plan to the plurality of users.

2. The method of claim 1 further comprising creating demand, cost, actual spending, and development status reports for the course.

3. The method of claim 2 where the development status reports comprise course status, issues, accomplishments and projected course start and finish dates.

4. The method of claim 1 further comprising tracking changes between the learning plan and updated learning plans.

5. The method of claim 1 further comprising providing users over disparate systems to access the learning plan.

6. The method of claim 5 where the users concurrently update that learning plan.

7. The method of claim 1 further comprising creating a preliminary learning plan with known data.

8. The method of claim 7 where the known data comprises budget forecasts.

9. The method of claim 7 further comprising providing the preliminary learning plan to the users for feedback.

10. The method of claim 9 further comprising updating the preliminary learning plan in accordance with the feedback.

11. The method of claim 7 where the preliminary learning plan is approved when the users have no new feedback on the preliminary learning plan.

12. The method of claim 11 further comprising developing a detailed preliminary learning plan from the approved preliminary learning plan by prioritizing learning requests.

13. The method of claim 12 further comprising:
obtaining feedback on the detailed preliminary learning plan;
obtaining direct updates to the detailed preliminary learning plan from the users; and
approving the detailed preliminary learning plan when all the feedback is received.

14. A system for providing a business driven learning solution, comprising:
an input device to create a learning plan where the learning plan is implemented in a course for a determined time period;
an interface to send the learning plan to a plurality of users for display, where the interface receives approval of the learning plan by the plurality of users; and
a processor to update the learning plan during the determined time period in accordance with changes to budget, prioritization and training needs and to send the updated learning plan to the plurality of users.

15. The system of claim 1 where the processor creates demand, cost, actual spending, and development status reports for the course.

16. The system of claim 15 where the development status reports comprise course status, issues, accomplishments and projected course start and finish dates.

17. The system of claim 14 where the processor tracks changes between the learning plan and updated learning plans.

18. The system of claim 14 where the interface provides users over disparate systems to access the learning plan.

19. The system of claim 18 where the users concurrently update that learning plan.

20. The system of claim 14 where the processor creates a preliminary learning plan with known data.

21. The system of claim 20 where the known data comprises budget forecasts.

22. The system of claim 20 where the processor provides the preliminary learning plan to the users for feedback.

23. The system of claim 22 where the processor updates the preliminary learning plan in accordance with the feedback.

24. The system of claim 20 where the preliminary learning plan is approved when the users have no new feedback on the preliminary learning plan.

25. The system of claim 24 where the processor develops a detailed preliminary learning plan from the approved preliminary learning plan by prioritizing learning requests.

26. The system of claim 25 where the processor obtains feedback on the detailed preliminary learning plan, obtains direct updates to the detailed preliminary learning plan from the users, and approves the detailed preliminary learning plan when all the feedback is received.
